(19) United States
(12) Patent Application Publication
(10) Pub. No.: US 2026/0219030 A1
(43) Pub. Date: Jul. 30, 2026

(54) AUTOMATED INTERFEROMETRIC METROLOGY SYSTEM FOR USE WITH EXCHANGEABLE OPTICAL ELEMENT HAVING EMBEDDED CALIBRATION INFORMATION

(71) Applicant: Zygo Corporation, Middlefield, CT (US)

(72) Inventors: Nathaniel Sean Austin, Middletown, CT (US); Jacob Lee Beverage, Tucson, AZ (US); Paul Reisinger Mark, Lower Salford Township, PA (US); James Alan Soobitsky, Higganum, CT (US); Bruce Edward Truax, Southington, CT (US); Daniel James Musinski, Cromwell, CT (US); David Stephenson, Madison, CT (US); Daniel Mark Sykora, Palm City, FL (US)

(21) Appl. No.: 19/200,977

(22) Filed: May 7, 2025

Related U.S. Application Data
(60) Provisional application No. 63/750,932, filed on Jan. 29, 2025.

(51) Int. Cl. G01B 9/02055; G01B 11/24

(52) U.S. Cl. CPC G01B 9/02072; G01B 11/2441

(57) ABSTRACT

Disclosed is an interferometry system for measuring one or more properties of a test object, wherein the interferometry system is configured for use with at least one exchangeable optical element, and the interferometry system includes: an interferometer configured to combine a test wavefront derived from the test object with a reference wavefront to form an optical interference pattern on a detector when the test object and the exchangeable optical element are optically coupled with the interferometer; and an electronic controller coupled to interferometer and configured to analyze the optical interference pattern to determine metrology information about the test object; wherein the electronic controller is further configured to receive information from the exchangeable optical element, obtain calibration data about the exchangeable optical element based on the received information, and use the calibration data to reduce measurement uncertainty when determining the metrology information about the test object, and wherein the interferometry system optionally further comprises the exchangeable optical element.

### CROSS REFERENCE TO RELATED APPLICATIONS

This application claims priority to provisional application No. 63/750,932, filed Jan. 29, 2025, the contents of which is incorporated herein in its entirety.

### TECHNICAL FIELD

This disclosure relates to optical interferometry.

### BACKGROUND

An interferometer is a tool that uses light to measure one or more properties of a test object, such as surface figure (e.g., a map of surface height vs. lateral position), thickness variation, and/or refractive index variation. Typically, the interferometer directs a test wavefront to interact with the test object and combines the test wavefront with a reference wavefront to form an optical interference pattern on a detector in a plane optically conjugate with the portion of the test object of interest (e.g., a test surface of interest). Well-known techniques in the art such as phase-shifting can be used to extract a lateral phase map from the intensity variations in the optical interference pattern. The reference wavefront can be provided by a reference optic, such as a transmission flat or transmission sphere to provide a reference wavefront having a well-defined nominal shape. Assuming the reference wavefront is completely characterized, its contributions to the lateral phase map, if any, can be removed, so that the phase map can be directly correlated to optical path length variations caused by lateral variations in surface height, thickness, or refractive index in the test part. In addition to proper characterization of the reference wavefront (or the reference optic providing the reference wavefront), accurate measurements also require a lateral calibration to correlate lateral position with respect to pixels on a detector with actual lateral position on the test object.

Unfortunately, proper characterization of the reference wavefront and lateral calibration can be expensive, time-consuming, and/or cumbersome for the end-user, especially where the interferometry system is configured for use with different reference optics to provide different reference wavefronts for use in measuring correspondingly different test objects. For example, FIG. 1 is flow chart demonstrating user calibration and measurement steps commonly used today.

In step 110, the user mounts a λ/40 reference artifact to the interferometer (e.g., via some mounting receptacle). The term “artifact” is used herein to describe an optic that has certain features that have already been characterized and a λ/40 reference artifact is reference optic selected to have an extremely low departure from its target design. For example, for a reference flat, the reference artifact is flat to within λ/40, where A is the operating wavelength of the interferometer, which commonly use a Helium Neon laser source operating at around 633 nm. In steps 120 and 130, the user aligns the reference artifact and test object to the interferometer axis and one another. In step 140, the user provides an auxiliary artifact between the reference artifact and the test object, where the auxiliary artifact has premeasured lateral features for providing a lateral calibration. In step 150, the user performs a manual lateral calibration by using the camera in the interferometer to image the premeasured lateral features on the auxiliary artifact to determine a lateral scaling between objects in the field of view of the camera (such as the reference artifact and test object) and the detector image on the camera pixels. In step 160, the user removes the auxiliary artifact. In steps 170 and 180, the user triggers data acquisition to cause a system controller in the interferometry system to acquire and process interferometric images of the test object. In step 190, the system controller produces output results with measurement uncertainty better than λ/30 (e.g., better than 21 nm for a Helium Neon laser light source). This is possible because the target design of reference artifact was accurate to with a λ/40 (e.g., 16 nm). Notably this represents the currently best achievable performance for state-of the-art commercial optics.

### SUMMARY

One object of certain embodiments disclosed herein is to provide an interferometry system that automates certain aspects of lateral calibration so to provide better ease of use for the operator as well as mitigating against operator error.

Another object of certain embodiments disclosed herein is to provide an interferometry system that automates certain aspects of characterizing one or more optics that are removably incorporated into an interferometer, such as reference optics for establishing the reference wavefront with a desired shape and quality. This too provides better ease of use for the operator as well as mitigating against operator error.

Furthermore, another object of certain embodiments disclosed herein is to provide an interferometry system that automates certain aspects of characterizing one or more optics that are removably incorporated into an interferometer to enable the use of lower-quality, and therefore less expensive, optics. For example, rather than requiring a λ/40 reference artifact to achieve results better than λ/30, a much lower quality λ/10 reference artifact may be used.

In general, in one aspect, disclosed is an interferometry system for measuring one or more properties of a test object, wherein the interferometry system is configured for use with at least one exchangeable optical element. The interferometry system includes: a) an interferometer configured to combine a test wavefront derived from the test object with a reference wavefront to form an optical interference pattern on a detector when the test object and the exchangeable optical element are optically coupled with the interferometer; and b) an electronic controller coupled to interferometer and configured to analyze the optical interference pattern to determine metrology information about the test object. The electronic controller is further configured to receive information from the exchangeable optical element, obtain calibration data about the exchangeable optical element based on the received information, and use the calibration data to reduce measurement uncertainty when determining the metrology information about the test object. For example, the exchangeable optical element may be an exchangeable reference optical element that when optically coupled with the interferometer is configured to reflect, transmit, or diffract light provided by the interferometer to form the reference wavefront. The interferometry system optionally further includes the exchangeable optical element, or a set of such exchangeable optical elements.

Embodiments of the interferometry system may include any of the following features.

The exchangeable optical element may be a reference flat, a reference sphere, or a computer-generated hologram. For example, the exchangeable optical element may include a reflective or transmissive surface having a nominal surface profile and wherein the calibration data includes information about deviations of the surface from the nominal surface profile. The nominal surface may have a surface figure uncertainty greater than one-twentieth of a wave and less than one-quarter of a wave, where the wave is the wavelength of operation of the interferometer, or more narrowly, the nominal surface may have a surface figure uncertainty greater than one-tenth of a wave and less than one-fifth of a wave. For example, the nominal surface profile may be a planar profile or a spherical profile. The wavelength of operation is commonly around 633 nm (the wavelength of a Helium Neon laser), corresponding to an uncertainty between about 32 nm and 158 nm, or more narrowly between about 63 nm and 126 nm. Moreover, in other embodiments the operational wavelength may be different from 633 nm, however, the absolute uncertainty measurements in nm may still be applicable. In another example, the exchangeable optical element may include a diffractive structure having a nominal optical thickness profile wherein the calibration data includes information about deviations of the diffractive structure from the nominal optical thickness profile and/or wavefront errors introduced by the presence of the diffractive structure. For example, the nominal optical thickness profile may correspond to a computer-generated hologram.

The exchangeable optical element may include one or more fiducial marks configured to be imaged by the detector in the interferometer, and wherein the calibration data includes information about the sizes and/or positions of the fiducial marks. For example, the one or more fiducial marks may include at least three spatially separated fiducial marks. Alternatively, or in addition, in certain embodiments, the interferometer includes mechanical fixturing to releasably mount the exchangeable optical element to the interferometer so that the at least one surface of the exchangeable optical element has a pre-set angular orientation with respect to an optical axis of the interferometer.

The presence of the exchangeable optical element in the interferometer may introduce distortions to imaging of the test object by the interferometer onto the detector, and wherein the calibration data includes corrective mapping information to reduce the distortions.

For example, the calibration data may include any combination of one or more of deviations of the surface or optical thickness of the exchangeable optical element from a nominal surface profile or optical thickness profile, the sizes and/or positions of the fiducial marks, and corrective mapping information to reduce distortions caused by the presence of the exchangeable optical element in the interferometer.

The exchangeable optical element may include an embedded electronic memory storing the information. Alternatively, or in addition, a portion of the exchangeable optical element includes may include an optically readable pattern encoding the information.

The information received by the electronic processor may be an identification of the exchangeable optical element and wherein the electronic processor is configured to retrieve the calibration data based on the identification, e.g., from a locally or remotely stored electronic memory. Alternatively, or in addition, the information received by the electronic controller includes the calibration data so that the electronic controller can directly obtain the calibration data by receiving the information.

The interferometry system may further include a communication system operable by the electronic controller and configured to access the information from the exchangeable optical element and provide the information to the electronic processor. For example, the communication system may include an electronic communication system configured to access an electronic memory embedded in the exchangeable optical element. For example, the electronic communication system may include an electrically wired connection between electronic processor and the exchangeable optical element when the exchangeable optical element is optically coupled with the interferometer. Alternatively, for example, the electronic communication system may include a wireless electronic communication system. Furthermore, in certain embodiments, the communication system may include an opto-electronic communication system, such as a fiber optic communication system, configured to read a pattern formed on the exchangeable optical element when the exchangeable optical element is optically coupled with the interferometer. For example, in certain embodiments, a portion of the exchangeable optical element includes an optically readable pattern encoding the information and imageable by the detector in the interferometer and wherein the electronic processor is configured to receive the information from the detector when the exchangeable optical element is optically coupled with the interferometer.

The electronic processor may be configured to use the calibration information to correct a lateral phase map indicative of a surface or thickness of the test object for deviations of a surface or thickness of the exchangeable optical element from a nominal profile. For example, the lateral phase map may correspond to a height map of a surface of the test object. Alternatively, or in addition, the electronic processor may be configured to use the calibration information to determine a lateral calibration between a detector image and an object in a field of view of the interferometer. Moreover, in certain embodiments, the lateral calibration includes corrections for lateral distortions caused by the presence of the exchangeable optical element.

For example, in certain embodiments, the metrology information about test object determined by the electronic controller includes a lateral phase map indicative of a surface or thickness of the test object, and wherein the electronic controller is configured to determine the lateral phase map based on the detected optical interference pattern and the calibration data including the information about the deviations of the surface or thickness of the exchangeable optical element from the nominal profile. The electronic processor may be configured to determine an initial lateral phase map based on the detected optical interference pattern and remove contributions to the initial phase map caused by the deviations of the surface or thickness of the exchangeable optical element from the nominal profile to provide a final lateral phase map.

Furthermore, in certain embodiments, the calibration data includes the size of at least one of the fiducial marks, wherein the interferometer is configured to image the at least one fiducial mark onto the detector, and wherein the electronic processor is configured to identify the at least one fiducial mark in the detector image and determine a lateral scaling between an object in a field of view of the interferometer and the detector image. Furthermore, in certain embodiments, the metrology information about test object determined by the electronic controller includes a lateral phase map indicative of a surface or thickness of the test object, and wherein the electronic controller is configured to determine the lateral phase map based on the detected optical interference pattern and the lateral scaling.

Furthermore, in certain embodiments, the calibration data includes the positions of multiple fiducial marks formed on the exchangeable optical element, wherein the interferometer is configured to image the fiducial marks onto the detector, and wherein the electronic processor is configured to identify the fiducial marks in the detector image and determine an angular orientation for the exchangeable optical element with respect to optical axis for the interferometer. Furthermore, the metrology information about test object determined by the electronic controller may include a lateral phase map indicative of a surface or thickness of the test object, and wherein the electronic controller is configured to determine the lateral phase map based on the detected optical interference pattern, the calibration data including the information about the deviations of the surface or thickness of the exchangeable optical element from the nominal profile, and the determined angular orientation. For example, the electronic processor may be configured to determine an initial lateral phase map based on the detected optical interference pattern, orient the deviations of the surface of the exchangeable optical element from the nominal surface profile based on the determined angular orientation, and remove contributions to the initial phase map caused by the deviations of the surface or thickness of the exchangeable optical element from the nominal profile based on the oriented deviations to provide a final lateral phase map.

Furthermore, in certain embodiments, the calibration data includes the sizes and positions of multiple fiducial marks formed on the exchangeable optical element, wherein the interferometer is configured to image the fiducial marks onto the detector, and wherein the electronic processor is configured to identify the fiducial marks in the detector image and determine a lateral scaling between an object in a field of view of the interferometer and the detector image and an angular orientation for the exchangeable optical element with respect to optical axis for the interferometer, wherein the metrology information about test object determined by the electronic controller includes a lateral phase map indicative of a surface or thickness of the test object, and wherein the electronic controller is configured to determine the lateral phase map based on the detected optical interference pattern, the calibration data including the information about the deviations of the surface or thickness of the exchangeable optical element from the nominal profile, and the determined lateral scaling and angular orientation.

Furthermore, in certain embodiments, the calibration data includes corrective mapping information to reduce distortions caused by the presence of the exchangeable optical element in the interferometer, and the sizes and positions of multiple fiducial marks formed on the exchangeable optical element, wherein the interferometer is configured to image the fiducial marks onto the detector, and wherein the electronic processor is configured to identify the fiducial marks in the detector image and determine a lateral scaling between an object in a field of view of the interferometer and the detector image and an angular orientation for the exchangeable optical element with respect to optical axis for the interferometer, and further wherein the metrology information about test object determined by the electronic controller includes a lateral phase map indicative of a surface or thickness of the test object, and wherein the electronic controller is configured to determine the lateral phase map based on the detected optical interference pattern, the calibration data including the corrective mapping information, and the determined lateral scaling and angular orientation. For example, the electronic processor may be configured to determine an initial lateral phase map based on the detected optical interference pattern, orient and scale the corrective mapping information, and remove the contributions to the initial phase map caused by the lateral distortions based on the oriented and scaled corrective mapping information.

In yet further embodiments, the calibration data includes the sizes and positions of multiple fiducial marks formed on the exchangeable optical element, deviations of a surface or thickness of the exchangeable optical element from a nominal profile, and corrections for lateral distortions caused by the presence of the exchangeable optical element, wherein the interferometer is configured to image the fiducial marks onto the detector, and wherein the electronic processor is configured to identify the fiducial marks in the detector image and determine a lateral scaling between an object in a field of view of the interferometer and the detector image and an angular orientation for the exchangeable optical element with respect to optical axis for the interferometer, and further wherein the metrology information about test object determined by the electronic controller includes a lateral phase map indicative of a surface or thickness of the test object, and wherein the electronic controller is configured to determine the lateral phase map based on the detected optical interference pattern, the calibration data including the information about the deviations of the surface or thickness of the exchangeable optical element from the nominal profile and the corrective mapping information, and the determined lateral scaling and angular orientation. For example, the electronic processor may be configured to determine an initial lateral phase map based on the detected optical interference pattern, orient and scale the information about the deviations of the surface or thickness of the exchangeable optical element from the nominal profile and the corrective mapping information, and remove the contributions to the initial phase map caused by the deviations of the surface of the exchangeable optical element from the nominal surface profile based on the oriented and scaled deviations and the contributions to the initial phase map caused by the lateral distortions based on the oriented and scaled corrective mapping information.

In yet further embodiments, the calibration data is dependent on temperature, pressure, and/or humidity, and the interferometry system further includes one or more atmospheric sensors electronically coupled to the electronic controller and configured to measure temperature, pressure, and/or humidity, and wherein the electronic controller is further configured to use the measurement of the temperature, pressure, and/or humidity when using the calibration data to reduce the measurement uncertainty in the determined metrology information about the test object.

In yet further embodiments, the calibration data is dependent on a direction of gravity with respect to the orientation of the exchangeable optical element when the exchangeable optical element is optically coupled with the interferometer, and the exchangeable optical element includes a gravity sensor, temperature, and wherein the pressure, and/or humidity, wherein the interferometry system further includes one or more atmospheric sensors electronically coupled to the electronic controller and configured to measure temperature, pressure, and/or humidity, and wherein the information provided to the electronic controller further includes the direction of gravity sensed by the exchangeable optical element.

In yet further embodiments, the exchangeable optical element includes an embedded electronic memory storing the information and the electronic processor is further configured to send updated information to the embedded electronic memory based on one or more metrology determinations carried out by the electronic processor.

In yet further embodiments, the interferometer is configured to be optically coupled to a second exchangeable optical element and form the optical interference pattern based on the test wavefront, the reference wavefront, and second reference wavefront derived from the second exchangeable optical element, and wherein the electronic controller is further configured to receive second information from the second exchangeable optical element, obtain second calibration data about the second exchangeable optical element based on the received second information, and use the calibration data for both the first and second exchangeable optical elements to reduce measurement uncertainty when determining the metrology information about the test object.

The metrology information about the test object may include information about any of topography of one or more surfaces of the test object, refractive index or refractive index variations through at least a portion of the test object, and/or a shape of a wavefront propagated through at least a portion of the test object. The exchangeable optical element may include a transmission flat, a transmission sphere, a null lens, a computer-generated hologram, an aperture converter, or a beam expander. The interferometer may implement a Fizeau configuration, a Michelson configuration, a Twyman-Green configuration, a Mach-Zehnder configuration, or a Linnik configuration. The interferometer may include a light source for generating the test and reference wavefronts. Furthermore, in certain embodiments, the interferometry system may include a remote chamber for housing the exchangeable optical element.

In yet another aspect, disclosed is an exchangeable optical element for use with an interferometry system for measuring one or more properties of a test object, wherein the optical element is configured to be removably optically coupled with an interferometer in the interferometry system, and wherein the reference optical element includes an automated means for providing information to an electronic controller in the interferometry system, wherein the information relates to calibration data about the exchangeable optical element.

Embodiments of the exchangeable optical element may include any of the following.

The exchangeable optical element may be a reference optical element that when optically coupled with the interferometer is configured to reflect, transmit, or diffract light provided by the interferometer to form the reference wavefront. For example, the exchangeable optical element may include a reference flat, a reference sphere, or a computer-generated hologram.

The exchangeable optical element may include a reflective, transmissive, or diffractive portion having a nominal profile and wherein the calibration data includes information about deviations of the portion from the nominal profile.

Alternatively, or in addition, the exchangeable optical element may include one or more fiducial marks configured to be imaged by the detector in the interferometer, and wherein the calibration data includes information about the sizes and/or positions of the fiducial marks. For example, the one or more fiducial marks may include at least three spatially separated fiducial marks. Furthermore, the presence of the exchangeable optical element in the interferometer may introduce distortions to imaging of the test object by the interferometer onto the detector, and the calibration data may further include corrective mapping information to reduce the distortions.

The exchangeable optical element may further include mechanical connecting means to releasably mount the exchangeable optical element to the interferometer.

The automated means for providing information may include an embedded electronic memory storing the information and configured to be electronically coupled to the electronic processor. The automated means for providing information may include an optically readable pattern encoding the information and configured to be opto-electronically coupled to the electronic processor.

The information received by the electronic processor may be an identification of the exchangeable optical element and wherein the electronic processor is configured to retrieve the calibration data based on the identification from a local or remote database. Alternatively, the information provided by exchangeable optical element may be the calibration data.

Other aspects, embodiments, and advantages follow.

### DESCRIPTION OF DRAWINGS

FIG. 1 is a flow chart showing steps of a prior art measurement process.

FIG. 2 is a rendering of a portion of an interferometer receptable for mounting a reference optical element.

FIG. 3 is a rendering of a portion of a reference optical element configured to be removably mounted to the interferometer receptable in FIG. 2.

FIG. 4 is a flow chart showing steps for a measurement process.

FIG. 5 is a schematic diagram of an interferometry system for measuring plano test object.

FIG. 6 is a schematic for converting one set of spatial coordinates to another set of spatial coordinates.

FIG. 7 is a schematic diagram of an interferometry system for measuring a spherical test object.

FIGS. 8A, 8B, and 8C are measured surface height maps of a spherical test part, where FIG. 8A shows the measurement including surface figure error from the reference part, FIG. 8B shows the surface figure error itself, and FIG. 8C removes the surface figure error from the measurement.

FIG. 9 is a schematic diagram of an interferometry system for measuring the transmitted wavefront of a transmissive planar test object.

FIG. 10 is a schematic diagram of reference artifact showing fiducial marks.

FIGS. 11A and 11B are schematic diagrams of reference artifact showing different locations for an optically readable pattern for identifying the reference artifact and enabling retrieval of calibration information for the reference artifact by a system controller for the interferometry system implementing the reference artifact.

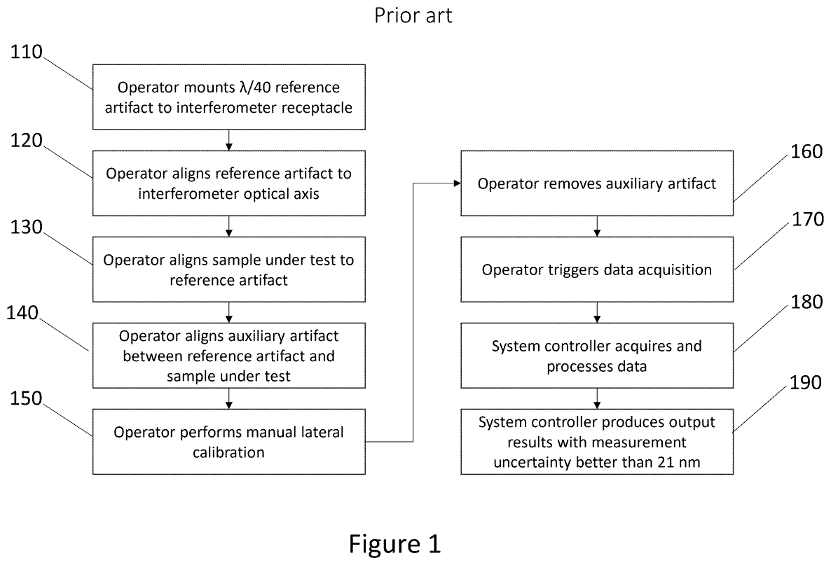

Common reference numerals in different figures refer to common features.

### DETAILED DESCRIPTION

Embodiments disclosed herein include an apparatus including a removable reference artifact combined with an interferometer and programmable controller to measure properties of a test object by analyzing the interference pattern created by combining on a detector light, reflected or transmitted by the reference artifact and light that interacts with the object under test. Notably, the reference artifact and interferometer controller include a means to communicate information from the reference artifact to the interferometer controller (and optionally, in certain embodiments, from the interferometer controller back to the reference artifact) that uniquely identifies the reference artifact and/or provides calibration information. For example, the reference artifact can be specifically identified individually (e.g., by part type and serial number), or by a lot number, where it is understood that reference artifacts from a common lot are sufficiently similar to within necessary measurement tolerances. The programmable controller is configured to use the unique identifier information to retrieve information about the reference artifact (e.g., from locally stored or remote database). The retrieved information enables accounting in the metrology results provided by the instrument for some attributes of the reference artifact thereby causing the resulting metrology data to have reduced measurement uncertainty. Moreover, the process of retrieving the information, deriving a correction and applying it to measured data can be performed entirely by the programmable controller without operator intervention.

In certain embodiments, the information communicated from the reference artifact to the interferometer controller can be the actual calibration information for the reference artifact, rather than just an identifier, so that the interferometer controller directly obtains the information, rather than retrieving it from a database with the identifier.

In certain embodiments the reference artifact is equipped with fiducial marks that create measurable features in the data collected by the instrument and the retrieved information about the reference artifact includes location and/or size of fiducial marks embedded into the reference artifact. As explained further below, the fiducial marks enable an automated lateral calibration for the interferometer.

Furthermore, in certain embodiments, the retrieved information about the reference artifact includes figure and waviness error as well as the location and size of fiducial marks embedded into the reference artifact, which enables scaling and registration of the figure error information with respect to the data collected by the instrument, for example for the purpose of improving measurement accuracy.

In yet further embodiments, the retrieved information also includes mapping functions to correct optical imaging distortions caused by the presence of the reference artifact.

In yet further embodiments, the retrieved information includes figure error information with associated scaling behavior as a function of operating temperature, humidity or atmospheric pressure, and wherein the interferometry system further includes sensors to provide measurements for temperature, humidity, and/or pressure so that the interferometric controller can determine the atmospherically correct figure error information from the retrieved information. In yet further embodiments, the retrieved information includes the dependence of the correction data on the direction of gravity to account, e.g., for gravity-dependent deformations of the optic, and wherein the reference artifact includes an embedded sensor to detect the direction of gravity and also provides this information to the system controller.

In certain embodiments, the system includes mechanical fixturing to mount the reference artifact with the interferometer with sufficient location accuracy (e.g., sufficient accuracy for the angular orientation of the reference artifact with respect to an optical axis for the interferometer) that a meaningful gain in measurement accuracy can be obtained for figure error without the need for the fiducial markers. For example, the mechanical fixturing can include any of notches, pins, holes, prongs, springs, and/or optional magnets.

Properties of a test object determined by the interferometry system can include information about topography of one or more surfaces, refractive index or refractive index variations through a medium, or shape of a wavefront that propagated through a test object or medium.

Interchangeable reference artifacts include, for example, transmission flats, transmission spheres, null lenses, computer generated holograms, aperture converters, beam expanders and combinations thereof.

The detector for the interferometer may include a multi-sensor element device such as a digital camera.

The means to exchange information that uniquely identifies the reference artifact to the interferometer controller may include communication between electronic devices embedded in the instrument and reference artifact, where communication takes place wirelessly or via physical electrical connections. Communication can also be enabled by means of a hybrid optical/electronics sub-system, including for example optical fibers and transceivers, or an optical encoding scheme, so that the instrument can record an image of a barcode or Quick Response (QR) code present on the reference artifact.

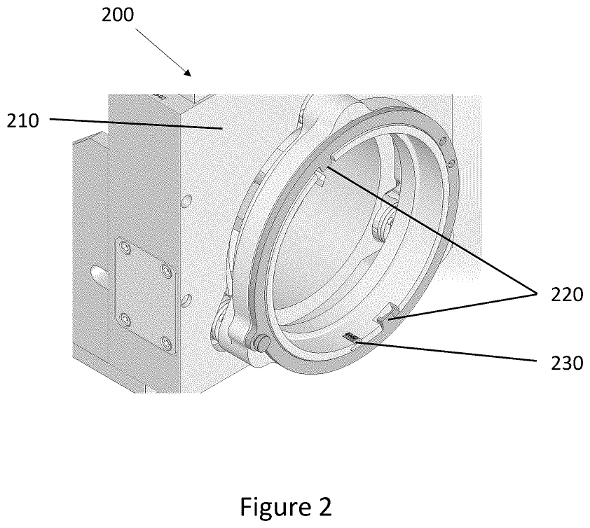

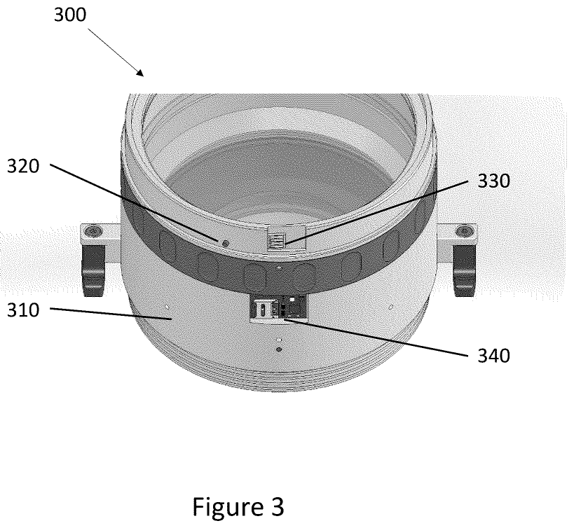

FIGS. 2 and 3 depict renderings of one embodiment a suitable interferometer and reference artifact. Specifically, FIG. 2 shows a mechanical interface on body 210 of an interferometer receptacle 200 configured to mount a reference artifact 300 (shown in FIG. 3), such as a transmission flat or transmission sphere. The interface includes mechanical locking mechanisms 220 that are used to secure the reference artifact 300 to the body 210 of the interferometer receptacle, and an electric connector 230 which interfaces to a matching electrical connector 330 on the body 310 of the reference artifact 300. The electronic connector 230 is electronically coupled to an electronic controller (not shown in FIG. 2) for the interferometry system. FIG. 3 shows the reference artifact 300, including the matching electrical connector 330. The body 310 of the reference artifact 300 also includes mechanical locating pins 320 that interlock with locking mechanisms 220 on the body 210 of the interferometer receptacle. The reference artifact 300 further includes an electronic memory chip 340 that stores unique information about the reference artifact (e.g., unique identifier information for the reference artifact and/or calibration data for the reference artifact). The electronic memory chip 340 is electrically connected to matching electrical connector 330, and ultimately to the electronic controller for the interferometry system when the reference artifact 300 is mechanically and electrically coupled to the interferometer receptacle 200.

The electronic controller can automatically retrieve the information about the reference artifact either by retrieving it directly for implementations in which all of the information is stored in the electronic memory chip 340 in the reference artifact mount, or by retrieving the information from a repository, such as a computer database on a local or remote network, based on identification information provided by electronic memory chip 340.

Retrieved information about the reference artifact can include figure deviation from design, waviness and roughness surface information, relative location and dimensions of fiducial marks, and relative location of the fiducial marks with respect to the figure error information. Figure and waviness information can be conveyed using one or more polynomial models of the surface, such as Zernike, Legendre or Cartesian polynomials, or high density 2-dimensional arrays of data that are interpolated to generate figure error information, or a combination of these representations. The electronic controller for the interferometry system can size the reference information to match the magnification of the optical instrument and the orientation (e.g., clocking) and lateral position (in a direction perpendicular to the optical axis of the interferometer) of the reference artifact with respect to the optical instrument and its light detector.

Other types of information retrieved by the electronic controller include image distortion and image mapping functions, either for a nominal design, or measured for the specific reference artifact, or both.

In further embodiments, the electronic coupling between connectors 230 and 330 is replaced by other automated means for communicating the reference artifact information from the reference artifact to the electronic controller, such as electronic components providing wireless communication and/or opto-electronic components, including, for example, fiber optical components and/or optical readers. For example, in the later case the information stored in the reference artifact is encoded in an optically readable pattern, rather than stored in electronic memory chip 340.

The removably attached reference artifact storing the information can be implemented in a variety of interferometers, including, without limitations, configurations such as Fizeau, Michelson, Twyman-Green, Mach-Zehnder, Linnik or interferometers based on Wide Field concepts, such as those disclosed in commonly owned U.S. Pat. No. 8,045,175. Moreover, the interferometer light source may include any of laser, extended, fiber-fed, broadband, or tunable light sources.

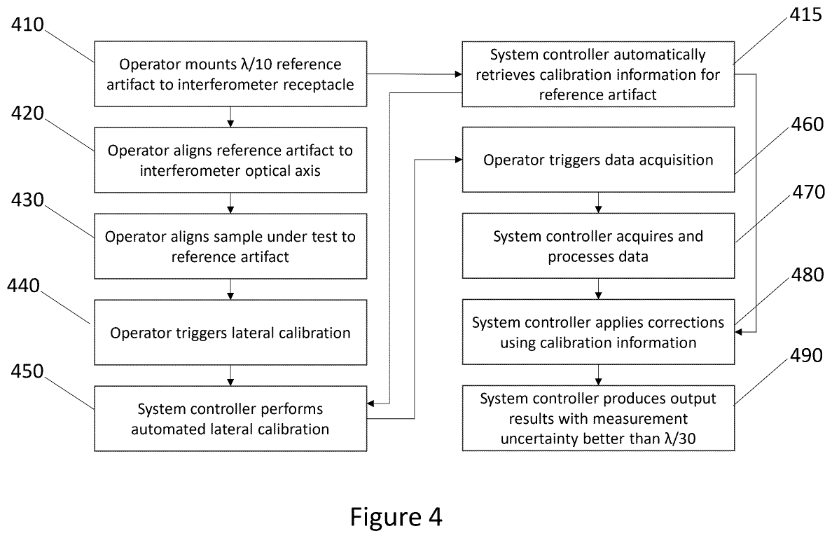

FIG. 4 is a flow chart demonstrating how the disclosed embodiments can improve an interferometric measurement of a sample under test yielding a measurement output with an uncertainty of figure error better than 21 nm (also known as a “thirtieth of a wave” in optical shops, or “λ/30” where λ is the wavelength of the interferometer light source, typically 633 nm for a Helium Neon laser), including accurate mapping of the location of sample features by result of an additional lateral calibration of the instrument.

In step 410, the user mounts a λ/10 reference artifact to the interferometer receptacle. (e.g., via a mounting receptacle). In steps 420 and 430, the user aligns the reference artifact and test object to the interferometer axis and one another. Contemporaneously, in step 415, the electronic controller for the interferometry system automatically retrieves calibration information for reference artifact. In steps 440 and 450, the operator triggers lateral calibration (step 440), and then electronic controller automatically performs the lateral calibration using at least some of the calibration information for the reference artifact (step 450). In steps 460 and 470, the operator triggers data acquisition (step 460), and then the electronic processor acquires and processes the data (e.g., sets of phase-shifted interference pattens formed on the interferometer detector). In step 480, the electronic controller applies corrections to the processed data using at least some of the calibration data for the reference artifact. For example, the calibration data can include deviations from a nominal surface figure for the reference artifact and electronic controller can automatically remove such deviations from the processed data. As a result, in step 490, the electronic processor can output metrology results with measurement uncertainty better than λ/30 (e.g., better than 21 nm for a Helium Neon laser light source).

Notably, in the absence of the corrections made by the electronic controller based on the information from the reference artifact, the resulting measurement uncertainty would be worse than 63 nm (a “tenth of a wave” or “λ/10”) corresponding to the accuracy of the lower quality λ/10 reference artifact being used. However, the process flow shows that owing to the information that the electronic controller can retrieve about the reference artifact, for example, information about the dimensions and locations of fiducial marks that are measurable by the interferometer, the electronic controller can perform an automated lateral calibration and registration procedure that is operator independent and performed under ideal imaging conditions since no auxiliary artifact is required. Moreover, the electronic controller can use the lateral scaling to properly orient and scale information derived from the reference artifact about deviations of the surface figure of the reference artifact from its nominal surface figure (e.g., deviations from flatness for a transmission flat). As a result, the electronic controller can generate corrected data with final measurement uncertainty to better than 21 nm despite using the lower quality λ/10 reference artifact. Moreover, the process reduces dependence on operator skill and training. In practice, under well-controlled environmental conditions the interferometry system disclosed herein can enable correction of the contributions of the reference artifact to the measurement uncertainty to better than 13 nm (a “fiftieth of a wave”), or even 6 nm (a “hundredth of a wave”), something not achievable without correction.

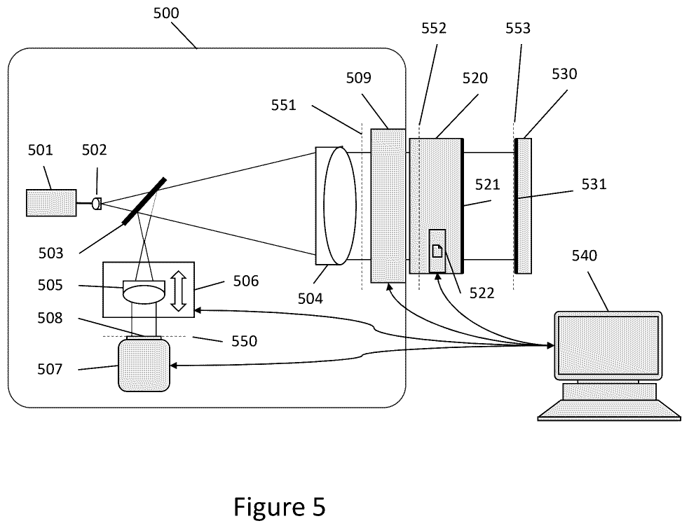

The following paragraphs provide an example of practical implementation of the functionality outlined above. FIG. 5 shows an interferometry system including an interferometer 500 and an electronic processor 540 (or equivalently an “electronic system controller 540” or simply “system controller 540”) for controlling the interferometer. The interferometer is configured to removably mount a reference artifact 520 to enable the surface metrology of a test object 530, which in this example is substantially planar (or “plano”) sample. The interferometer 500 includes a light source 501, such as a laser, which creates a beam of light that is transformed into a spherical wave by condenser lens 502, before propagating through a beamsplitter 503 and being collimated into a plane wavefront by a collimator 504. A fraction of the illumination wavefront reflects from an optical surface 521 within the reference artifact 520 to create a reference wavefront while another fraction propagates to a sample surface 531 on the plano test object 530, where it reflects and returns toward the interferometer 500 as the sample wavefront (or equivalently, the “test wavefront”), after passing through reference artifact 520. The light reflected by the reference artifact and the sample surface is reflected by beamsplitter 503 toward ocular lens 505, which creates an image of the sample surface onto the sensing area 508 of detector 507. The sample surface is brought into focus onto the sensor by adjustment of focus control element 506. The sample and reference wavefronts interfere on the sensing area 508 to create the light intensity distribution, or interferogram (or “interference pattern”), that is measured at multiple spatial locations by detector 507. The interferometer also includes a modulating element 509 used to introduce controlled optical path length variations in the interferometric cavity.

System controller 540 controls the operation of the instrument, for example by collecting multiple datasets from the detector 507 for various optical path lengths introduced by modulating element 509. These data are processed by a computer embedded in the controller to compute the phase and amplitude of the interferogram, for example, via a phase-shifting algorithm, as is well-known in the art. In this example, the phase information (or “phase map”) is converted to surface topography information of sample surface 531 (e.g., to provide surface height as a function of lateral position). The controller also communicates with information storage device 522, embedded in reference artifact 520, to retrieve calibration information about reference artifact 520. The controller uses this information to reduce uncertainty contributors to the surface topography information, such as the deviation from flatness of optical surface 521.

Using the information from or identified by the reference artifact, the controller can perform an automated lateral calibration to properly convert the data recorded in the coordinate system of the detector pixels to actual positions in one or more planes within the interferometer, such as actual positions in the plane of the reference surface 521 and test surface 531, or conjugate planes thereto, as explained below.

The plane surface of the detector defines a first mathematical plane 550 within which one can define an orthonormal coordinates system (Oₚ, xₚ, yₚ). Individual sensor elements (e.g., camera pixels) are assigned coordinates (xₚ, yₚ) that correspond to their location within the sensor array and the periodic spacing of the sensor array elements. The system controller is provided with a numerical model (x, y)=ƒ(xₚ, yₚ) that defines the mapping between locations (xₚ, yₚ) on plane 550 and physical locations (x, y) on virtual plane 551 located between collimator 504 and the reference artifact 520. Function ƒ(xₚ, yₚ) can be expressed as an analytical function or polynomial model. For example, the simple numerical model of Eq. (1) corresponds to a well-corrected telecentric optical system of magnification m.

$$( x , y ) = ( m {x}_{p} , {my}_{p} ) \qquad ( 1 )$$

Mapping function ƒ(xₚ, yₚ) can be determined in advance for interferometer 500 and stored in system controller 540.

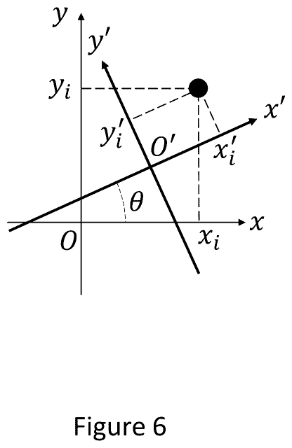

In certain embodiments, the calibration information associated with reference artifact 520 includes information about the location of fiducial marks embedded within the reference artifact. For instance, this information may take the form of numerical dimensions and locations of the fiducial marks within a local coordinate system (O′, x′, y′) defined at a virtual plane 552 located at reference artifact. Taking the example of circular fiducial marks, the information includes the diameter Dᵢ and center location (x′ᵢ, y′ᵢ) of the n fiducial marks present on the reference artifact, as shown in FIG. 6.

Automated lateral calibration and registration of the reference artifact is accomplished by the system controller with the following sequence of steps.

First, the controller adjusts the position of focusing element 506 to bring the fiducial marks embedded in reference artifact 520 in focus on detector 507. This is accomplished using nominal information stored in the controller or using information available in the set of information retrieved about the reference artifact by communicating with information storage device 522. The controller then acquires one or more measurements of the intensity distribution at the sensor, which provides a digitized image of the fiducial marks, as observed on the detector. Using conventional image processing tools, such as edge detection and edge fitting, or computation of the centroid of a selection of locations on the sensor that define the image of each fiducial, and then applying mapping function ƒ(xₚ, yₚ), the controller computes the locations (xᵢ, yᵢ) of the center of the n fiducial marks, as shown in FIG. 6.

The measured fiducial mark locations (xᵢ, yᵢ) in the coordinate system of the interferometer and the known positions (x′ᵢ, y′ᵢ) of the n fiducial marks in the coordinate system of the reference artifact allow setting a system of 2n equations that map one coordinate system to the other, as shown by Eq. (2). The unknown parameters are the scale factor s, coordinate system shift (x₀, y₀), and rotation angle θ. These 4 parameters provide the registration and lateral calibration necessary to enable the invention.

$$\{ \begin{matrix}{x}_{i}^{′} = s [ cos θ ( {x}_{i} - {x}_{0} ) - sin θ ( {y}_{i} - {y}_{0} ) ] \\ {y}_{i}^{′} = s [ sin θ ( {x}_{i} - {x}_{0} ) + cos θ ( {y}_{i} - {y}_{0} ) ] \\ …\end{matrix} \qquad ( 2 )$$

While two fiducial marks are theoretically sufficient to determine the 4 unknown parameters, reference artifacts are generally equipped with at least three fiducial marks to avoid any ambiguities about the azimuthal clocking of the reference artifact and its orientation with respect to the interferometer since some reference artifacts such as reference flats can be used facing toward or away from the interferometer. With three or more fiducial marks the system of equations in Eq. (2) is over-constrained and an optimization solver is used to determine optimum parameters that minimize a merit function such as:

$$M ( s , θ , {x}_{0} , {y}_{0} ) = {\sum }_{i = 1}^{N} \begin{matrix}{\{ {x}_{i}^{′} - s [ cos θ ( {x}_{i} - {x}_{0} ) - sin θ ( {y}_{i} - {y}_{0} ) ] \}}^{2} + … \\ {\{ {y}_{i}^{′} - s [ sin θ ( {x}_{i} - {x}_{0} ) + cos θ ( {y}_{i} - {y}_{0} ) ] \}}^{2}\end{matrix} \qquad ( 3 )$$

The system controller is now configured with all the required information to apply correction to metrology data according to the calibration information available for the reference artifact. The combination of mapping function ƒ(xₚ, yₚ) and the transform defined by Eq. (2) allows the system controller to map measurement locations on the sensor to physical locations on the part.

Once registration and lateral calibration parameters have been automatically determined by the system controller, it becomes possible for an operator of the instrument to initiate a measurement of the surface deviation of the sample under test as in the following sequence. First, the system controller performs a data acquisition and generates a topography map of the surface deviation of the sample under test using, for example, a combination of phase-shifting, phase unwrapping and conversion of phase data to surface topography data considering the wavelength of the laser source, as is well-known in the art.

The system controller then applies corrections to the topography data using the calibration information about the reference artifact. In a first step, it retrieves calibration information that defines the surface topography error induced by imperfection of the reference artifact itself. This takes the form of a set of polynomial coefficients that are used to predict the induced error W(x′, y′) at any location (x′, y′) within the clear aperture of the reference artifact. For each sensor element location (xₚ, yₚ) for which the controller determined a topography deviation value h(xₚ, yₚ) for the sample surface 531, the controller computes a corresponding location (x, y)=ƒ(xₚ, yₚ) on virtual plane 551. These coordinates are then converted to coordinates (x′, y′) for the same physical location but now expressed within the coordinate system of the reference artifact:

$$\{ \begin{matrix}{x}^{′} = s [ cos θ ( x - {x}_{0} ) - sin θ ( y - {y}_{0} ) ] \\ {y}^{′} = s [ sin θ ( x - {x}_{0} ) + cos θ ( y - {y}_{0} ) ]\end{matrix} \qquad ( 4 )$$

The controller can then compute the estimated error W(x′, y′) induced by the reference artifact at that location and apply a correction to derive a more accurate surface deviation estimate h′(xₚ, yₚ) according to:

$${h}^{′} ( {x}_{p} , {y}_{p} ) = h ( {x}_{p} , {y}_{p} ) - W ( {x}^{′} , {y}^{′} ) \qquad ( 5 )$$

The result of the operations is a corrected surface topography deviation map h′(xₚ, yₚ) sampled at the sensor locations (xₚ, yₚ). Such information is sufficient for certain metrology applications, for instance when the goal of the operator is to verify that the Peak-to-Valley or Root Mean Square surface deviation, or some other measurand derived from the corrected data matches a given manufacturing specification. However, some applications require not only accurate measurement of the surface deviation along the normal to the surface, but also accurate determination of the lateral position of the surface features, for example when the goal is to derive information about locations on the part where a subsequent manufacturing operation is required, and even taking into account lateral deviations caused by the presence of the reference artifact itself.

In this case, the controller can perform an additional correction of the data as follows. First, the controller retrieves calibration information identified by the reference artifact that further includes additional numerical parameters that allow computing a mapping operation that relate the lateral coordinates (x′, y′) of a location on virtual plane 552 to a location (x″, y″) on virtual plane 553 located at the sample. This mapping operation g(x′, y′) is defined for example as a combination of analytical and polynomial functions. Its purpose is to undo any mapping distortions introduced by the reference artifact when the illumination and reflected wavefronts travel to the sample surface and back, passing through the reference artifact optics. For example, if the reference artifact were removed, g(x′, y′) is simply an identify function, g(x′, y′)=(x′, y′).

While not always necessary, it is often desired to preserve the sample azimuthal orientation in the final data reported by the instrument. This is accomplished by accounting for the rotation θ that was determined during lateral calibration and registration. The computation of the sample coordinates then takes the form:

$$( \begin{matrix}{x}^{″} \\ {y}^{″}\end{matrix} ) = ( \begin{matrix}cos θ & sin θ \\ - sin θ & cos θ\end{matrix} ) g [ ( \begin{matrix}{x}^{′} \\ {y}^{′}\end{matrix} ) ] \qquad ( 6 )$$

The controller can then assign the corrected topography data h′(xₚ, yₚ) to the corresponding physical sample locations (x″, y″). While the sampling locations (xₚ, yₚ) on the sensor are typically organized along a periodic rectangular grid, the corresponding locations (x″, y″) are not expected to match such a periodic rectangular grid. It is sometimes desirable to revert to such periodic rectangular grid sampling for subsequent data processing steps, such as digital filtering. In this case, the controller uses a resampling algorithm that interpolates the set of deviation data (x″, y″, h′) over a set of regularly spaced locations

$$( {x}_{i}^{″} , {y}_{j}^{″} ) .$$

In the example above, the calibration information received by the system controller and identified and/or provided by the removable reference artifact include the size and location of the fiducial marks, the surface figure deviations for the reference surface, and mapping functions to correct for the lateral distortions caused by the presence of the reference artifact. And, as a result, the system controller provides the automated lateral calibration, including the correction of the lateral distortions, as well as correcting for the surface figure deviations of the reference surface. Other embodiments may implement fewer or different corrections.

For example, in some embodiments, it is possible that the surface figure deviations for the reference surface are sufficiently small (e.g., W(x′, y′)<1 nm) that the correction in Equation 5 can be ignored. What remains however is the automated lateral calibration that enables the system controller to output the metrology information with respect to the actual lateral coordinates of the test surface based on the characterizations of the fiducial markers and, optionally, the mapping functions that correct for the lateral distortions caused by the presence of the reference artifact. For example, whether or not W (x′, y′) is small and can be ignored, the topography deviation map h′(xₚ, yₚ) or h(xₚ, yₚ) sampled at the sensor locations (xₚ, yₚ), can be converted to locations at the test surface at plane 553 using the mapping functions provided by Equations 3, 4 and 6.

Furthermore, in other embodiments, it may not be necessary to determine the angular orientation of the reference artifact based on the fiducial marks because the mechanical mounting of the reference artifact to the interferometer provides sufficient angular accuracy. In this case, the system controller can modify the above Equations to set the angle θ to zero, which can simplify the implementation of the correction of the surface figure deviations for the reference surface of the reference artifact.

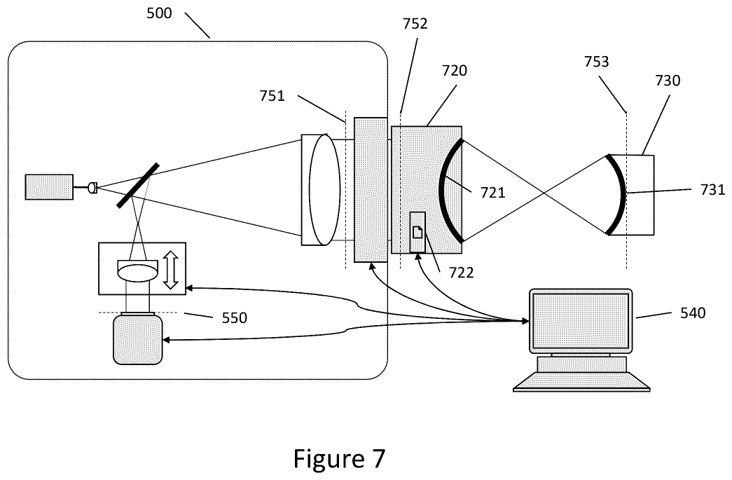

The example in FIG. 5 was for a plano test surface, but many other implementations are possible. For example, FIG. 7 illustrates the interferometry system being used to measure a spherical test surface. Specifically, in this implementation, the reference artifact 720 is a transmission sphere that converts the plane illumination wavefront coming from interferometer 500 into a spherical wavefront. The reference artifact has a nominally spherical reference optical surface 721 that has the same center of curvature as the spherical illumination wavefront that propagates toward the spherical surface 731 of the sample under test 730.

The automated calibration and registration process carried out by system controller 540 for this configuration is substantially the same as the process described for the plano cavity configuration shown in FIG. 5. Again, the required information about the location of fiducial marks on surface 721 is retrieved from, or identified by, storage device 722 embedded in reference artifact 720. As in the previous configuration, the system controller computes a location (x′, y′) on a virtual plane 752 for the reference artifact for each sensing element location (xₚ, yₚ) defined on plane 550. This again enables the computation of a measurement correction W(x′, y′) that is applied to the surface deviation data h(xₚ, yₚ) computed at (xₚ, yₚ) according to Eq. (4)-(5).

For some applications the system controller retrieves additional numerical parameters from storage device 722 that allow computing a mapping operation that relate the lateral coordinates (x′, y′) of a location on the virtual plane 752 to a location (x″, y″) on a virtual plane 753 located at the sample surface. This mapping operation g(x′, y′) is defined for example as a combination of analytical and polynomial functions. Again, its purpose is to undo any mapping distortions introduced by the reference artifact when the illumination and reflected wavefronts travel to the sample surface and back, passing through the reference artifact optics. Because of the measurement geometry the mapping operation requires an additional dimensional parameter such as the nominal radius of curvature of the surface under test (a numerical value provided by the operator), or the distance between the vertex of surfaces 721 and 731, or the diameter of the clear aperture of surface 731 (assuming it is smaller than the field of view of the interferometer imaging aperture.) For this operation, the controller also makes use of the radius of curvature R_{TS} of reference surface 721, which is also retrieved from, or identified by, storage device 722. In the case of an optical design that introduces negligible mapping errors, the mapping function can take a form as simple as:

$$( \begin{matrix}{x}^{″} \\ {y}^{″}\end{matrix} ) = \frac{{R}_{s}}{{R}_{T S}} ( \begin{matrix}cos θ & sin θ \\ - sin θ & cos θ\end{matrix} ) ( \begin{matrix}{x}^{′} \\ {y}^{′}\end{matrix} ) \qquad ( 7 )$$

where Rₛ is the nominal radius of curvature of surface 731 and the rotation matrix preserves the sample azimuthal clocking with respect to the interferometer. In the case where the instrument measures automatically the distance L between the vertex of surfaces 721 and 731, the radius of curvature of the sample surface is derived as Rₛ=R_{TS}−L. For example, one way for the instrument to measure automatically the distance L between the vertex of surfaces 721 and 731 is to implement the techniques in commonly
U.S. patent application Ser. No. 18/820,386, entitled “INTERFEROMETRIC METHOD FOR MEASURING OPTICAL DISTANCE” and filed on Aug. 30, 2024, the contents of which are incorporated herein by reference.

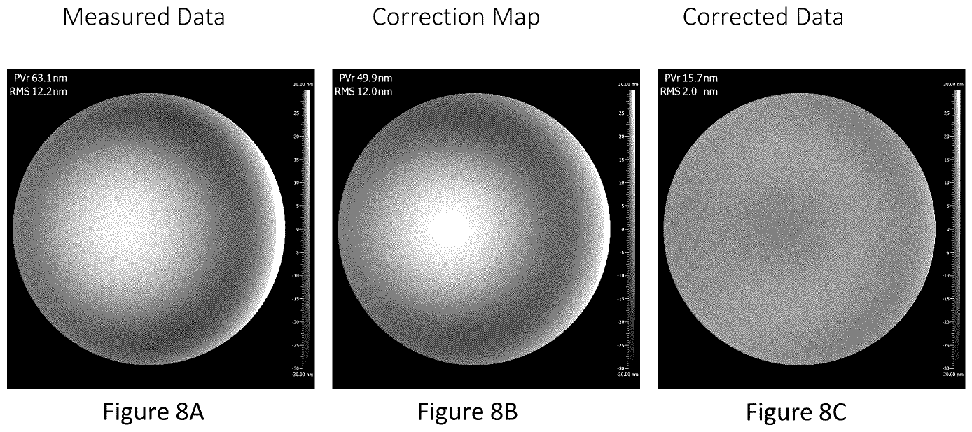

FIGS. 8A-C shows an actual example that can be implemented by the above interferometry system when implementing the spherical reference artifact. Specifically, FIG. 8A shows an example of measurement result h(x″, y″) where the uncorrected surface topography deviation of a spherical part is reported as having a 63 nm deviation from the ideal spherical shape. The correction map in FIG. 8B is generated according to the Equations above for lateral calibration by the computation of correction function W(x′, y′) and based on calibration data for the reference artifact. FIG. 8C shows the corrected surface deviation h′(x″, y″) based on the above equations, which has a peak-to-valley deviation of less than 16 nm.

As demonstrated above, the calibration information retrieved for the reference artifact can be used to compute and compensate for the effect of manufacturing imperfections, such as figure error of one or more optical surfaces within the artifact, on the final metrology results reported by the system. For example, for a reference artifact that creates a spherical reference wavefront used to measure the departure from sphericity of optical surfaces, the figure imperfections of the reference artifact can result in a measurement error in the figure of the optical surface under test bounded between one tenth and one twentieth of the wavelength of light used by the interferometer. The disclosed embodiments enable computing this measurement error and performing a correction of the metrology data, yielding metrology data for which the measurement error is less than a fortieth of a wavelength, or less than a fiftieth, or less than a hundredth of the wavelength of light, thus substantially reducing measurement uncertainty.

While the specific examples above were for planar and spherical reference surfaces, respectively, in other embodiments, the reference artifact can be a diffractive structure, such as a Computer Generated Holograms (CGH), in which case the calibration information includes a map of the figure or wavefront errors induced by the substrate that carries the diffractive pattern, as well as one or more maps that allow to predict the figure or wavefront error induced by the diffractive pattern into the various diffraction orders used for metrology. For example, the map may include deviations of the laterally varying optical thickness of the diffractive structure from its design.

As also explained above, in some embodiments, the calibration information retrieved about the reference artifact can be used to correct mapping errors of the imaging system. Mapping errors result in a distortion of the lateral coordinates of the measured data compared to their actual location on the sample under test. Such mapping errors can be a property of the nominal design of the reference artifact, thus affecting all artifacts of that type in the same way, such as is the case for certain transmission sphere or CGH designs, or the result of manufacturing imperfections, which affect each individual artifact differently. Correcting for both types of mapping errors reduces measurement uncertainty. In the case of beam expanders and aperture converters the calibration information may contain precise magnification values which allow the lateral calibration of the interferometer to be computed in object space.

In some embodiments the calibration information includes the optical design of the artifact, such as list of surfaces, refractive indices, diffractive patterns, element spacings, tolerances as used in lens design software, or functions that enable the computation of the optical path accumulated by a ray of light as it propagates from a real or virtual reference surface on one side of the artifact to a real or virtual reference surface on the other side of the artifact, as a function of the position and angle of incidence of the incoming ray on the first reference surface, and as a function of the wavelength of light. Such information can enable the correction of a variety of uncertainty contributions that result from an optical design, sometimes called retrace errors, and enable the determination of sensitivity functions that are used to compute measurement errors induced by misalignments of the reference artifact to the interferometer, or of the sample under test to the reference artifact.

In yet further embodiments, the calibration information can include information about how the measurement errors induced by the reference artifact vary as a function of environmental parameters such as temperature, humidity or atmospheric pressure, or the direction of the force of gravity. In such cases, the interferometry system can further include atmospheric sensors that monitor these environmental conditions to compensate for drifts or changes of the operating environment. Such sensors are electronically coupled to the system controller for the interferometry system so that the system controller can combine the sensor information with the calibration data to determine the correction as a function of the atmospheric conditions. For example, the correction can be provided, for example, in the form of scaling functions that describe how the coefficients of Zernike or Legendre polynomials vary in response to change in environmental parameters. These polynomials can be used to compute an additional correction component applied to the measured data to further reduce their measurement uncertainty.

In yet further embodiments, the information about the reference artifact includes definitions of its mechanical datums and interfaces and the relative position of characteristics of the artifact that define its optical function, such as the location and angular direction of the optical axis, principal and nodal planes, entrance and exit pupil, etc. Such information can be used for example in the context of actuating a motorized mount that carries the artifact to align the artifact to the interferometer or the unit under test.

Furthermore, in some embodiments, the interferometry system may implement more than one reference artifact to perform a measurement on a test object. Reference artifacts as described herein can be combined to enable complex metrology configurations. For example, the removable reference artifacts can include a beam expander and a transmission sphere, or a beam expander and a CGH, which are optically coupled to one another to produce a desired reference wavefront (or wavefronts). In such cases, the system controller is provided with one communication channel for each reference artifact to retrieve their respective calibration and compensation information.

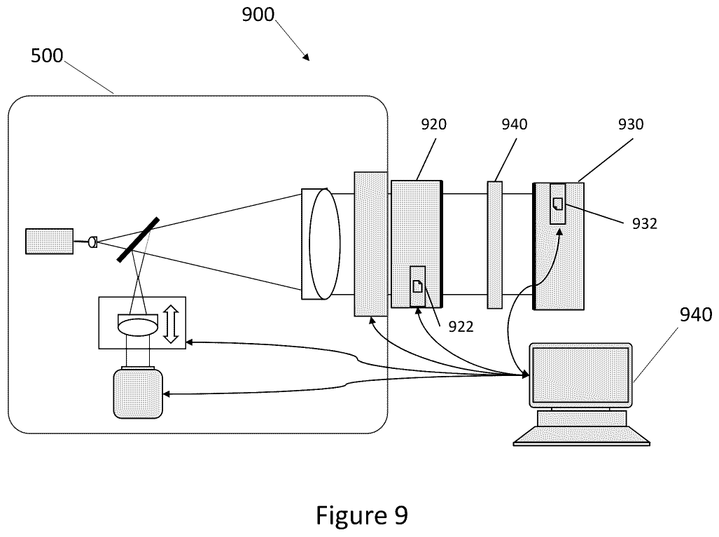

FIG. 9 is shown an interferometry system 900 including interferometer 500 and system controller 940 configured for use with two plano reference artifacts 920 and 930 that are combined to enable the metrology of the transmitted wavefront error of a nominally plane parallel optic 940 under test. Each reference artifact includes an electronic memory chip 922 and 932, respectively, that is in electrical communication with system controller 940 to provide or identify the respective calibration information for the artifacts. In this example, the interference pattern is formed from the interference between the reference wavefront that reflects from the plano reference surface of reference artifact 920 and the test wavefront that transmits through test object 940, is reflected by the plano reference surface of reference artifact 930, and then passes back through the test object. The system controller 940 can isolate the measured transmitted wavefront error caused by the double-pass through test object by accounting for the deviations from the nominal planar design of the two plano references surfaces of the two reference artifacts using the calibration information retrieved or identified by the system controller based on its communication with the electronic memory chips.

In some embodiments, fiducials marks are placed non evenly on the reference artifact and follow a layout that is different for different reference artifacts. For example, the markers can be round features that are located a fixed distance from the optical axis of the reference artifact and distributed azimuthally with specific angular separations. The angular separations are selected with asymmetry to enable aligning the reference data unequivocally to the fiducials. For instance, when using 3 fiducial markers, the azimuthal separation is a different angle for each pair of fiducials. This enables the system controller to determine the azimuthal orientation of the artifact as well as the side of the artifact that is facing the interferometer, since some reference artifacts can be used with both orientations.

Fiducial marks can be manufactured by permanently marking the optical surface of the accessory such that the mark is visibly within the field of the light detector by means such as laser marking, etching, sand blasting, painting and other techniques. Fiducial marks can be shaped as circles, discs, crosses, or other geometric shapes suitable for accurate localization in an image via image processing means.

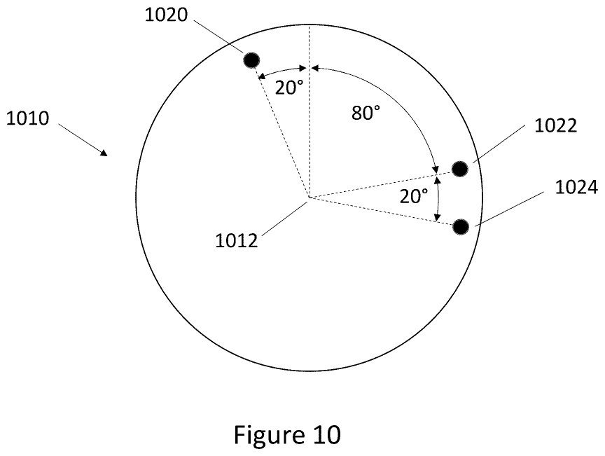

Fiducial marker locations are also optimized in preferred embodiments to provide large baselines to assess the magnification of the optical imaging system. As described above, by measuring the distance between the markers in the image created on the detector and retrieving an estimate of their physical separation as part of the calibration information retrieved for the reference artifact, the instrument automatically determines the sampling step equivalent to one detector element on the surface of the sample under test. Such lateral calibration information enables the interferometry system to accurately determine, for example, the physical separation of features on the sample, the size of its bounding aperture, and/or the location of some features with respect to some datums. Using different patterns for different reference artifacts enables the system to identify the type of artifact even in situations where communication between the interferometer and the artifact is disabled. FIG. 10a shows one example of a layout or three circular fiducial marks 1020, 1022, 1024 on a reference artifact 1010, where each fiducial mark is equidistant from the center 1012 of the reference optic, with angular orientations of −20 degrees, 80 degrees, and 100 degrees with respect a 12 o'clock reference.

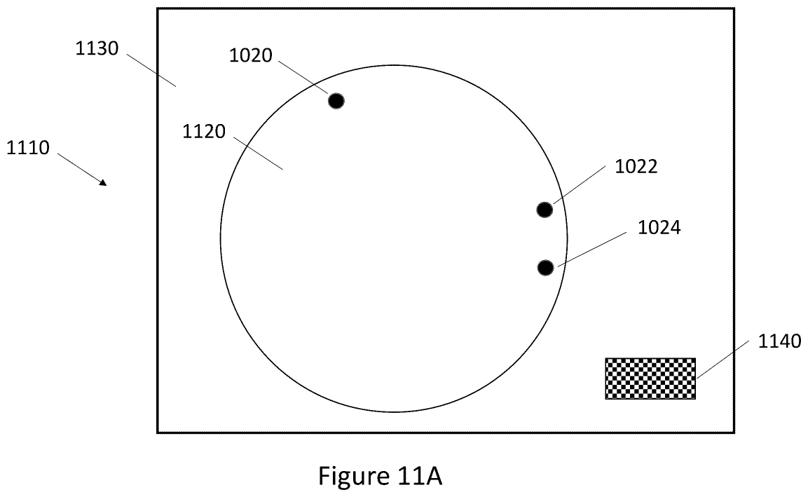

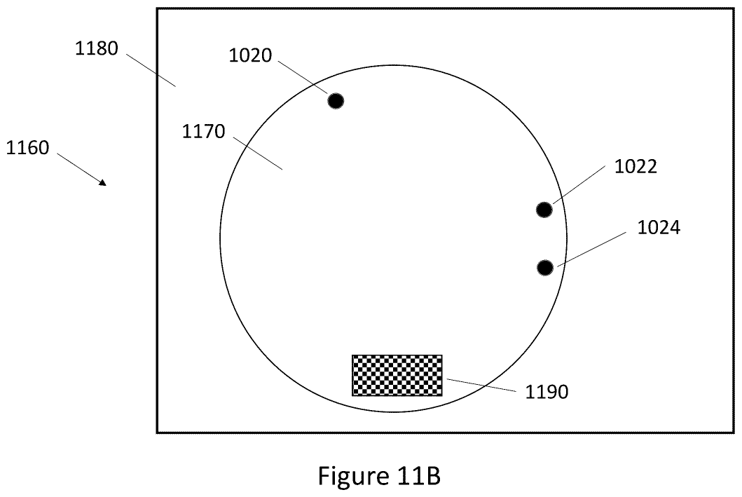

In some of the specific embodiments described above, the reference artifact includes an electronic memory chip to store or identify the calibration data. As also described above, however, in other embodiments, the reference artifact includes an optically readable pattern encoding the information that can provide or identify the calibration data. For example, FIG. 11A shows reference artifact 1110 having an optical portion 1120 configured to be in the field of view of the interferometer and an outer body 1130, where the outer body includes the optically readable pattern 1140. For example, the pattern 1140 can be read by an optical reader coupled to the system controller for the interferometry system. In another example, FIG. 11B shows reference artifact 1160 having an optical portion 1170 and an outer body 1180, where the optically readable pattern 1190 is located on the optical portion 1170 within field of view of the interferometer so that the pattern can be read directly by the camera in the interferometer. However, this has the disadvantage of obscuring a portion of the measurement field for the interferometer.

In yet further embodiments, the reference artifact is not directly attached to the interferometer. For example, a remote receptacle can be used to position the reference artifact with respect to the object under test. The remote receptacle is equipped with means of communication with the instrument controller to enable the controller to retrieve information from the reference artifact. Applications include placing the reference artifact in an environmental chamber, vacuum chamber, or in a remote location away from the interferometer when measuring large optics.

In yet further embodiments, the instrument performs an automated calibration sequence when a reference artifact is detected by the system controller. For instance, the information retrieved for the reference artifact may include quantitative information that enables the interferometer to drive its focus mechanism in such a way that the fiducial markers are in focus on the image sensor. This enables the acquisition of metrology data (intensity, phase) that can be used to automatically locate the fiducial markers with respect to the coordinate system of the interferometer. That information is stored on the controller and later used to numerically compensate for reference artifact error contributions in the measurement data by laterally scaling and aligning the compensation data to the data measured by the instrument.

In yet further embodiments, the design of the information storage mechanism makes it possible for an end user to send the calibration artifact back to the factory for periodic recalibration. In this context, the retrievable information includes time stamps for past calibration and recommended dates for recalibration. The system controller optionally tags metrology data exported by the instrument with metadata that includes such time stamps. Factory calibration entails applying one of many prior art techniques for determining calibration information for the reference artifact, for example the figure error in the wavefront it generates and storing this latest information on the storage mechanism.

### Digital Implementations

The features of the electronic system controller or electronic processor can be implemented, at least in part, in digital electronic circuitry, or in computer hardware, firmware, or in combinations of these. For example, at least some of the features can be implemented in a computer program product tangibly embodied in an information carrier, e.g., in a machine-readable storage device, for execution by a programmable processor; and features can be performed by a programmable processor executing a program of instructions to perform functions of the described implementations by operating on input data and generating output. The described features can be implemented in one or more computer programs that are executable on a programmable system including at least one programmable processor, such as multiple processors, coupled to receive data and instructions from, and to transmit data and instructions to, a data storage system, at least one input device, and at least one output device. A computer program includes a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors one of multiple processors of any kind of computer. Generally, a processor will receive instructions and data from a read-only memory or a random-access memory or both. Computers include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; solid-state disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). The features can be implemented in a single process or distributed among multiple processors at one or many locations. For example, the features can employ cloud technology for data transfer, storage, and/or analysis.

Other embodiments are within the scope of the claims.

What is claimed is:

1. An interferometry system for measuring one or more properties of a test object, wherein the interferometry system is configured for use with at least one exchangeable optical element, the interferometry system comprising:
a. an interferometer configured to combine a test wavefront derived from the test object with a reference wavefront to form an optical interference pattern on a detector when the test object and the exchangeable optical element are optically coupled with the interferometer; and
b. an electronic controller coupled to interferometer and configured to analyze the optical interference pattern to determine metrology information about the test object;
c, wherein the electronic controller is further configured to receive information from the exchangeable optical element, obtain calibration data about the exchangeable optical element based on the received information, and use the calibration data to reduce measurement uncertainty when determining the metrology information about the test object, and
d, wherein the interferometry system further comprises the exchangeable optical element.

2. The interferometry system of claim 1, wherein the exchangeable optical element comprises a reflective or transmissive surface having a nominal surface profile and wherein the calibration data comprises information about deviations of the surface from the nominal surface profile.

3. The interferometry system of claim 1, wherein the exchangeable optical element comprises a diffractive structure having a nominal optical thickness profile wherein the calibration data comprises information about deviations of the diffractive structure from the nominal optical thickness profile and/or wavefront errors introduced by the presence of the diffractive structure.

4. The interferometry system of claim 1, wherein the exchangeable optical element comprises one or more fiducial marks configured to be imaged by the detector in the interferometer, and wherein the calibration data comprises information about the sizes and/or positions of the fiducial marks, wherein the one or more fiducial marks comprise at least three spatially separated fiducial marks.

5. The interferometry system of claim 2, wherein the exchangeable optical element further comprises one or more fiducial marks configured to be imaged by the detector in the interferometer, and wherein the calibration data further comprises information about the sizes and/or positions of the fiducial marks.

6. The interferometry system of claim 3, wherein the exchangeable optical element further comprises one or more fiducial marks configured to be imaged by the detector in the interferometer, and wherein the calibration data further comprises information about the sizes and/or positions of the fiducial marks.

7. The interferometry system of claim 1, wherein the presence of the exchangeable optical element in the interferometer introduces distortions to imaging of the test object by the interferometer onto the detector, and wherein the calibration data comprises corrective mapping information to reduce the distortions.

8. The interferometry system of claim 1, wherein the interferometer comprises mechanical fixturing to releasably mount the exchangeable optical element to the interferometer so that the at least one surface of the exchangeable optical element has a pre-set angular orientation with respect to an optical axis of the interferometer.

9. The interferometry system of claim 1, wherein the exchangeable optical element comprises an embedded electronic memory storing the information.

10. The interferometry system of claim 1, wherein a portion of the exchangeable optical element comprises an optically readable pattern encoding the information.

11. The interferometry system of claim 1, wherein the information received by the electronic processor is an identification of the exchangeable optical element and wherein the electronic processor is configured to retrieve the calibration data based on the identification.

12. The interferometry system of claim 11, wherein the electronic processor is configured to retrieve the calibration data from a locally or remotely stored electronic memory.

13. The interferometry system of claim 1, wherein the information received by the electronic controller comprises the calibration data so that the electronic controller directly obtains the calibration data by receiving the information.

14. The interferometry system of claim 1, further comprising a communication system operable by the electronic controller and configured to access the information from the exchangeable optical element and provide the information to the electronic processor.

15. The interferometry system of claim 1, wherein a portion of the exchangeable optical element comprises an optically readable pattern encoding the information and imageable by the detector in the interferometer and wherein the electronic processor is configured to receive the information from the detector when the exchangeable optical element is optically coupled with the interferometer.

16. The interferometry system of claim 1, wherein the electronic processor is configured to use the calibration information to correct a lateral phase map indicative of a surface or thickness of the test object for deviations of a surface or thickness of the exchangeable optical element from a nominal profile.

17. The interferometry system of claim 1, wherein the electronic processor is configured to use the calibration information to determine a lateral calibration between a detector image and an object in a field of view of the interferometer.

18. The interferometry system of claim 17, wherein the lateral calibration includes corrections for lateral distortions caused by the presence of the exchangeable optical element.

19. The interferometry system of claim 17, wherein the electronic processor is further configured to use the calibration information to correct a lateral phase map indicative of a surface or thickness of the test object for deviations of a surface or thickness of the exchangeable optical element from a nominal profile.

20. The interferometry system of claim 1, wherein the metrology information about test object determined by the electronic controller comprises a lateral phase map indicative of a surface or thickness of the test object, and wherein the electronic controller is configured to determine the lateral phase map based on the detected optical interference pattern and the calibration data, wherein the calibration data comprises information about deviations of a surface or thickness profile of the exchangeable optical element from a nominal profile.
